(19) United States
(12) Patent Application Publication
(10) Pub. No.: US 2010/0136231 A1
(43) Pub. Date: Jun. 3, 2010

(54) METHOD FOR PRODUCING A REFRIGERATION DEVICE

(75) Inventors: Marc-Oliver Güttinger, Herbrechtingen (DE); Carsten Jung, Herbrechtingen (DE); Martin Ziegler, Herbrechtingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/532,197

(22) PCT Filed: Mar. 14, 2008
(86) PCT No.: PCT/EP08/53090

§ 371 Date: Sep. 21, 2009

(30) Foreign Application Priority Data
Apr. 10, 2007 (DE) 10 2007 016 846.4

(51) Int. Cl. B05D 3/10

(52) U.S. Cl. 427/236

(57) ABSTRACT

A method is provided for producing a refrigeration device with a refrigerated interior that is delimited by an inner shell. The refrigeration device includes a space between the inner shell and an outer shell into which a curable insulating foam is injected. A sealing material is injected into the space before the injection of the insulating foam, the sealing material sealing joints or gaps and preventing the passage of the insulating foam through the joints or gaps.

The invention relates to a method for producing a refrigeration device according to the preamble of claim 1.

Refrigeration devices typically have a refrigerated interior that is delimited by easy-to-clean plastic walls. Contained in said interior are drawers or shelves for storing chilled or frozen foodstuffs. The refrigeration device is enclosed by an outer shell which protects the device against external influences. A space is provided between the plastic walls of the interior and the outer shell in order to ensure that no heat can penetrate into the interior from outside, said space being filled by injection with an insulating foam. For this purpose an injection opening for the insulating foam is usually provided in the motor compartment of the refrigeration device close to the rear wall. From said injection opening the insulating foam disperses in the space such that it fills the entire space uniformly and thereby insulates the interior uniformly at all points.

The inner shell is installed in the housing during the preassembly stage of the refrigeration device. Enclosures for electronic components and ducting for cables and leads are likewise already provided in the resulting space. At the same time joints are sometimes intentionally provided, said joints being required for example when components made of different materials have different coefficients of expansion. Gaps also arise due to assembly factors and as a result of manufacturing tolerances. Said joints and gaps must all be laboriously sealed before the interior space is filled with insulating foam, since otherwise the insulating foam will issue from the joints and gaps and can soil the outside of the housing. Similarly, the insulating foam can penetrate through such joints and gaps into enclosures for electronic components and make it impossible to accommodate the electronic components there. If the electronic components were already installed before the foaming-in-place of the space, said components can be rendered unusable by the insulating foam. In the prior art the insulating foam was prevented from passing through the joints and gaps by means of foam labyrinths, for example. At other points, joints and gaps were laboriously sealed with adhesive tape prior to the foaming-in-place process, which tape had to be removed again after the foaming-in-place process. All these measures which are intended to prevent the passage of insulating foam are expensive, time-consuming and labor-intensive.

The object underlying the invention is to embody a method for producing a refrigeration device in such a way that no time-consuming, labor-intensive and expensive production steps are necessary in order to seal off the space so that no insulating foam can escape from within the space.

The object is achieved according to the invention by means of a method for producing a refrigeration device having the features recited in claim 1. By injecting a sealing material into the space before the insulating foam is injected it is possible to cut down on all other sealing measures. At the same time the sealing material must be so constituted that it seals all joints and gaps which can occur in the case of the refrigeration device that is to be manufactured. The choice of suitable sealing material consequently depends on the width of the occurring joints and/or gaps.

The sealing material should be injected quickly and ideally automatically into the space in such a way that all joints and/or gaps can be reached and sealed by the sealing compound. Direct spraying of every joint and/or gap is not possible in practical terms. It has proved substantially more advantageous to atomize the sealing material during the injection process. The mist thus produced is deposited in a relatively large area of the space and seals the joints and/or gaps there.

In order to enable the refrigeration device to be completely preassembled already prior to the injection of the sealing material, the sealing material is advantageously injected via a nozzle which is inserted into the space through the outer shell. This enables a further assembly step following the injection of the sealing material to be eliminated. This is particularly cost-saving, since otherwise the appliances would have to be brought back into the preassembly area following the injection of the sealing material.

According to the invention, the nozzle is inserted so far into the space to ensure that it is positioned close to the joints and/or gaps that are to be sealed. In this way it is ensured that the mist produced also seals off all the joints and/or gaps. At the same time sealing material is saved, since it is not necessary to inject the entire space with sealant.

If the nozzle is inserted into the space through the rear wall, the points at which sealing problems are known to occur can be reached particularly effectively. In order to be able to insert the nozzle through the rear wall, corresponding openings can be provided for example in the rear wall. Said openings can be matched to the cross-section of the nozzle, though they can also consist of a cruciform cut, with the resulting free corners being pressed inward by the nozzle when penetrating through the rear wall. Said openings could be sealed in a simple manner following the injection of the sealing compound.

The rear walls of refrigeration devices are often made from a board-containing material. It is therefore particularly advantageous if the rear wall is perforated with the aid of the nozzle. In this way no preliminary operations of any kind are necessary and the same rear walls can be used as in the prior art. For this purpose the nozzle is provided with a tip which is pressed through the rear wall. The nozzle tip could additionally be provided with a cruciform cutter such that a cruciform cut is produced in the rear wall, with the nozzle tip being pressed through the center of said cut. This would have the advantage that after the nozzle is withdrawn only the cruciform incision remains in the rear wall and the nozzle would leave no hole which would have to be sealed in turn.

In order to be able to ensure that the rear wall will remain in its position during the perforation process and will not be displaced by the occurring forces, it is advantageously held by means of at least one suction device.

As a result of the atomizing of the sealing material a small amount of sealing material is also deposited on the nozzle itself. Advantageously, the nozzle is guided so tightly in the perforation of the rear wall that the deposited sealing material is stripped off when the nozzle is withdrawn. For the stripped-off sealing material to be able to seal the perforation it must already exhibit a certain viscosity. The nozzle is therefore left in its injection position until the sealing material has the necessary solidity.

If a refrigeration device has only very narrow joints and/or gaps, a lacquer can be used as the sealing compound. This can be an air-drying lacquer, for example. Equally, however, a multi-component lacquer could be used which cures after a predetermined time even without the action of the air.

With wider joints and/or gaps, a foam is advantageously used as the sealing material. Such a foam expands and is therefore better suited for sealing wider joints and/or gaps. In contrast to the insulating foam, however, this sealing foam does not penetrate through the joints and/or gaps, since the internal pressure in the space is not increased when the sealing foam is injected.

Further details and advantages of the invention will emerge from the dependent claims in conjunction with the description of an exemplary embodiment which is explained in detail with reference to the drawing, in which:

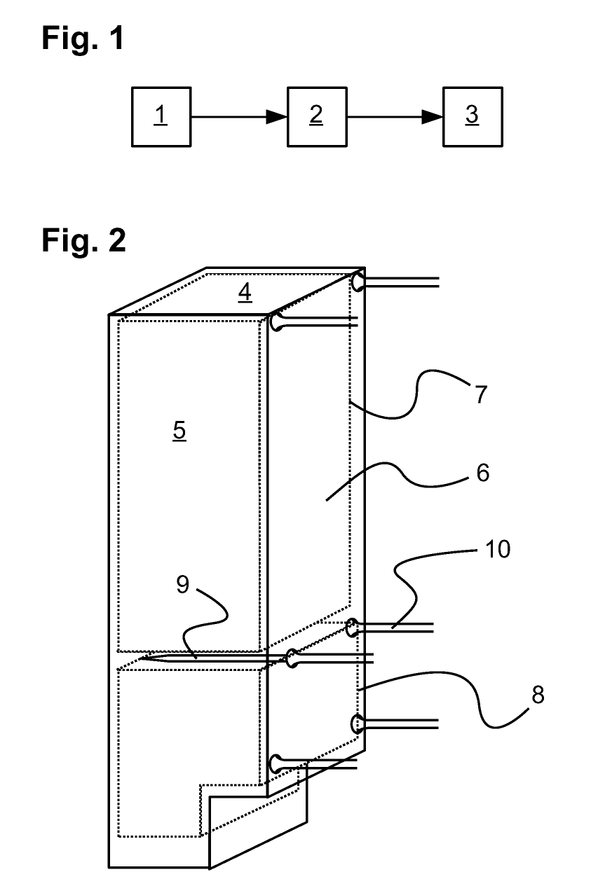

FIG. 1 shows a flowchart of the method according to the invention, and

FIG. 2 shows a refrigeration device during the injecting of the sealing material

The preassembly of the refrigeration device is designated by the reference sign 1 in FIG. 1. The reference sign 2 stands for the injecting of the sealing material in order to seal joints and/or gaps. The reference sign 3 denotes the injecting of the insulating foam.

The refrigeration device shown in FIG. 2 is a so-called fridge/freezer combination. The inner shell of the refrigeration compartment 7 and the inner shell of the freezer compartment 8 are provided for storing chilled and frozen foodstuffs. Both inner shells 7, 8 are mounted in a housing that has a cover 4, two sidewalls 5 and a rear wall 6. Also shown in FIG. 2 are six vacuum suction devices 10 which are placed on the rear wall 6. For clarity of illustration reasons only one injection nozzle 9 for the sealing compound is shown. However, each vacuum suction device 10 is assigned its own dedicated injection nozzle 9. The vacuum suction devices 10 are designed in such a way that they simultaneously constitute a guide for the injection nozzle 9. The injection nozzles 9 are embodied as pointed lances.

In the preassembly 1, the cover 4, the sidewalls 5 and a base part (not shown here) are connected to the outer housing of the refrigeration device. The rear of the housing is sealed with the rear wall 6. The inner shell for the refrigeration compartment 7 and the inner shell for the freezer compartment 8 are mounted in the housing. The assembly is carried out in such a way that a space which can be filled with insulating foam remains between the inner shells and the outer housing.

Following the preassembly 1, the refrigeration device is conveyed to a foaming system on its way to the injecting of the insulating foam 2. A further station for injecting the sealing compound 2 is provided on the way there. At said station the vacuum suction devices 10 with the injection nozzles guided therein are automatically attached at the predetermined points on the rear wall 6. After a vacuum has been created in order to stabilize the rear wall 6, the injection nozzles 9 are pushed through the rear wall 6 and in each case moved into a position from which the gaps and joints are easily accessible. The sealing compound is then injected.

The mist produced by the injection nozzles 9 condenses in the space and seals the joints and gaps. As soon as the curing process of the sealing compound has begun, the nozzles 9 are retracted in the guides of the vacuum suction devices 10. In the process the vacuum suction devices 10 continue to hold the rear wall 6 in position. When the injection nozzles 9 are retracted, sealing material that has deposited itself on the injection nozzles 9 is stripped off on the inside of the rear wall 6. As the nozzle tip passes through the opening in the rear wall 6, said opening is sealed with the stripped-off sealing material. An additional production step for sealing the openings is therefore not necessary. The vacuum suction devices 10 together with the injection nozzles 9 guided therein are now removed from the rear wall 6.

The refrigeration device can now be conveyed further into the foaming system in order for the insulating foam 3 to be injected. On the way there the sealing material can harden completely and seal the joints and gaps. The sealed joints and gaps withstand the pressure of the injected insulating foam and thereby ensure that no insulating foam passes through and causes damage that can only be rectified at great expense.

### LIST OF REFERENCE SIGNS

1 Preassembly

2 Injection of the sealing compound

3 Injection of the insulating foam

4 Cover

5 Sidewall

6 Rear wall

7 Inner shell of the refrigeration compartment

8 Inner shell of the freezer compartment

9 Injection nozzle for the sealing compound

10 Vacuum suction device

1-10. (canceled)

11. A method for producing a refrigeration device, the method comprising:
injecting a curable insulating foam into a space between an inner shell and an outer shell of a refrigeration device, the refrigeration device having a refrigerated interior delimited by the inner shell; and
before the step of injecting a curable insulating foam, injecting a sealing material into the space between the inner shell and the outer shell, the manner of injection of the sealing material and the properties of the sealing material being such that the injected sealing material substantially seals joints or gaps and substantially prevents the insulating foam from passing through the joints or gaps.

12. The method as claimed in claim 11, wherein injecting a sealing material includes atomizing the sealing material when being injected.

13. The method as claimed in claim 11, wherein injecting a sealing material includes injecting the sealing material via a nozzle that is inserted through the outer shell into the space between the inner shell and the outer shell.

14. The method as claimed in claim 13, wherein injecting a sealing material includes injecting the sealing material via a nozzle that is inserted into the space between the inner shell and the outer shell to an extent that the nozzle is located proximate to a joint or gap that is to be sealed.

15. The method as claimed in claim 13, wherein injecting a sealing material includes inserting the nozzle into the space between the inner shell and the outer shell via a rear wall of the outer shell that is made of a perforable material.

16. The method as claimed in claim 15, wherein inserting the nozzle into the space between the inner shell and the outer shell via the rear wall of the outer shell includes perforating the rear wall as a result of insertion of the nozzle.

17. The method as claimed in claim 16, wherein inserting the nozzle into the space between the inner shell and the outer shell includes holding the rear wall of the outer shell in a predetermined position via at least one suction device as the rear wall of the outer shell is perforated as a result of insertion of the nozzle.

18. The method as claimed in claim 16 and further comprising sealing the perforation in the rear wall created as a result of insertion of the nozzle with the sealing material upon withdrawal of the nozzle from the refrigeration device.

19. The method as claimed in claim 11, wherein injecting a sealing material includes injecting a lacquer.

20. The method as claimed in claim 11, wherein injecting a sealing material includes injecting a foam.
